(19) United States
(12) Patent Application Publication
(10) Pub. No.: US 2024/0056984 A1
(43) Pub. Date: Feb. 15, 2024

(54) FLOW-LEVEL COVERAGE AND BANDWIDTH ADAPTATION

(71) Applicant: AT&T Intellectual Property I, L.P., Atlanta, GA (US)

(72) Inventor: Thomas Novlan, Jonestown, TX (US)

(21) Appl. No.: 17/818,972

(22) Filed: Aug. 10, 2022

(51) Int. Cl. H04W 52/24; H04L 67/131; H04W 28/02

(52) U.S. Cl. CPC H04W 52/241; H04L 67/131; H04W 28/0263

(57) ABSTRACT

In one example, a method includes detecting an extended reality traffic flow exchanged between an extended reality application executing on a user endpoint device and an application server supporting the extended reality application, mapping the extended reality traffic flow to a radio access network-level metric, and adapting at least one of: a transmit power of the user endpoint device, a transmit power of a radio access node serving the user endpoint device, a frequency band of the user endpoint device, a channel bandwidth of the user endpoint device, a frequency band of the radio access node serving the user endpoint device, or a channel bandwidth of the radio access node serving the user endpoint device to meet the radio access network-level metric.

The present disclosure relates generally to extended reality (XR) applications, and relates more particularly to devices, non-transitory computer-readable media, and methods for flow-level coverage and bandwidth adaptation for XR applications.

### BACKGROUND

Mobile devices (e.g., smart phones, tablet computers, wearable devices, and the like) are often used to engage with network connected applications, such as streaming music and video applications, gaming applications, and others. At the same time, many of these applications are offering more immersive experiences, such as gaming applications that leverage extended reality (XR) technology. XR is an umbrella term that may encompass virtual reality (VR), augmented reality (AR), mixed reality (MR), and other immersive technologies.

### SUMMARY

In one example, the present disclosure describes a device, computer-readable medium, and method for flow-level coverage and bandwidth adaptation for extended reality applications. For instance, in one example, a method performed by a processing system including at least one processor includes detecting an extended reality traffic flow exchanged between an extended reality application executing on a user endpoint device and an application server supporting the extended reality application, mapping the extended reality traffic flow to a radio access network-level metric, and adapting at least one of: a transmit power of the user endpoint device, a transmit power of a radio access node serving the user endpoint device, a frequency band of the user endpoint device, a channel bandwidth of the user endpoint device, a frequency band of the radio access node serving the user endpoint device, or a channel bandwidth of the radio access node serving the user endpoint device to meet the radio access network-level metric.

In another example, a non-transitory computer-readable medium stores instructions which, when executed by a processing system, including at least one processor, cause the processing system to perform operations. The operations include detecting an extended reality traffic flow exchanged between an extended reality application executing on a user endpoint device and an application server supporting the extended reality application, mapping the extended reality traffic flow to a radio access network-level metric, and adapting at least one of: a transmit power of the user endpoint device, a transmit power of a radio access node serving the user endpoint device, a frequency band of the user endpoint device, a channel bandwidth of the user endpoint device, a frequency band of the radio access node serving the user endpoint device, or a channel bandwidth of the radio access node serving the user endpoint device to meet the radio access network-level metric.

In another example, a device includes a processing system including at least one processor and a computer-readable medium storing instructions which, when executed by the processing system, cause the processing system to perform operations. The operations include detecting an extended reality traffic flow exchanged between an extended reality application executing on a user endpoint device and an application server supporting the extended reality application, mapping the extended reality traffic flow to a radio access network-level metric, and adapting at least one of: a transmit power of the user endpoint device, a transmit power of a radio access node serving the user endpoint device, a frequency band of the user endpoint device, a channel bandwidth of the user endpoint device, a frequency band of the radio access node serving the user endpoint device, or a channel bandwidth of the radio access node serving the user endpoint device to meet the radio access network-level metric.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates a flowchart of an example method for providing flow-level coverage and bandwidth adaptation for an extended reality application in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides flow-level coverage and bandwidth adaptation for XR applications. As discussed above, mobile devices (e.g., smart phones, tablet computers, wearable devices, and the like) are often used to engage with network connected applications, such as streaming music and video applications, gaming applications, and others. At the same time, many of these applications are offering more immersive experiences, such as gaming applications that leverage extended reality (XR) technology. XR is an umbrella term that may encompass virtual reality (VR), augmented reality (AR), mixed reality (MR), and other immersive technologies.

XR applications typically tend to fall within one of three broad categories: enterprise applications, consumer applications, and mission critical applications. Examples of enterprise applications may include industrial automation, factory management and maintenance, and remote training and may leverage XR technologies including XR multimedia streaming, XR conversation, XR cloud gaming, AR guided assistance at remote locations, AR animated avatar calls, shared spatial data, and other XR technologies. Examples of consumer applications may include shopping and retail, immersive stadium experiences, and AR animated avatar calls and may leverage XR technologies including XR multimedia streaming, spatial audio multiparty calls, real time XR sharing, and other XR technologies. Mission critical applications may include first responder applications such as AR guided assistance and shared spatial data to assist firefighters (e.g., to locate shutoff valves or victims in burning buildings), XR conversational technology and viewport-dependent streaming to assist police in locating and collaborating with other first responders, and other applications.

The radio access network (RAN) performance of an XR application may be greatly impacted by the file size distribution of the XR application traffic. Unlike standard mobile broadband (which may utilize file transfer protocol) or video streaming traffic types, the sizes of packets associated with interactive applications—particularly those interactive applications that are dependent upon user environment—tend not to be fixed in size (although the sizes of the packets are typically dependent upon the encoding rate of the packet contents). Existing radio resource optimization frameworks tend to focus on adaptation of system- or user-level quality of service (QoS) requirements based on traffic type (e.g., voice, video, or the like). The QoS requirements are typically assessed across key performance indicators (KPIs) such as throughput, latency, jitter and the like. Thus, adaptation tends to be limited, since the mapping at a traffic source of a set of RAN-related parameters/configurations that are optimized for existing applications (e.g., mobile broadband, video streaming, voice services, Internet of Things (IoT), or the like) is not applicable to XR applications over a fifth generation (5G) RAN (and may even lead to significant performance loss or inability to meet system- or user-level QoS requirements). Additionally, energy saving considerations on both the device side and the network side (which may be common when using conventional devices designed for XR applications, such as wireless head mounted displays and controllers) may further complicate the ability to jointly optimize per-user performance for multiple users.

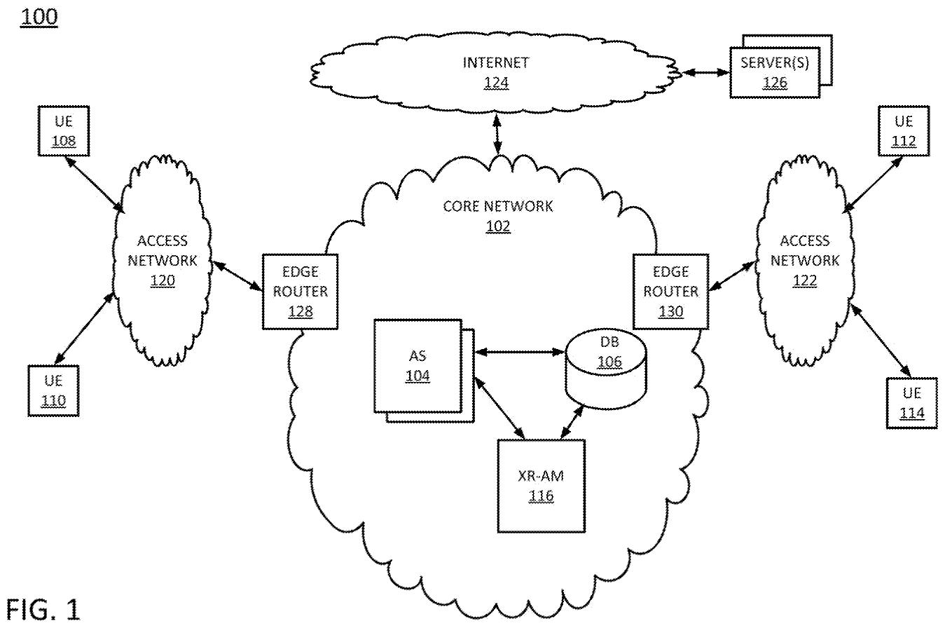

Examples of the present disclosure uniquely characterize and optimize XR application traffic (e.g., including AR traffic, VR traffic, and the like) within a 5G RAN in terms of coverage and energy metrics such as downlink and uplink transmit power, beam selection, frequency bandwidth, and/or other metrics. The coverage and/or bandwidth for an XR application may be adapted at the network traffic flow level. This may allow different flows carrying different traffic which may be associated with the same XR application (e.g., a flow carrying multimedia traffic, a flow carrying interactivity traffic, etc.) to be differentiated and to be independently and simultaneously optimized so that the overall user experience with the XR application meets some required QoS. These and other aspects of the present disclosure are described in greater detail below in connection with the examples of FIGS. 1-3.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks 120 and 122, and the Internet 124. In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server, an interactive TV/video on demand (VoD) server, and so forth.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

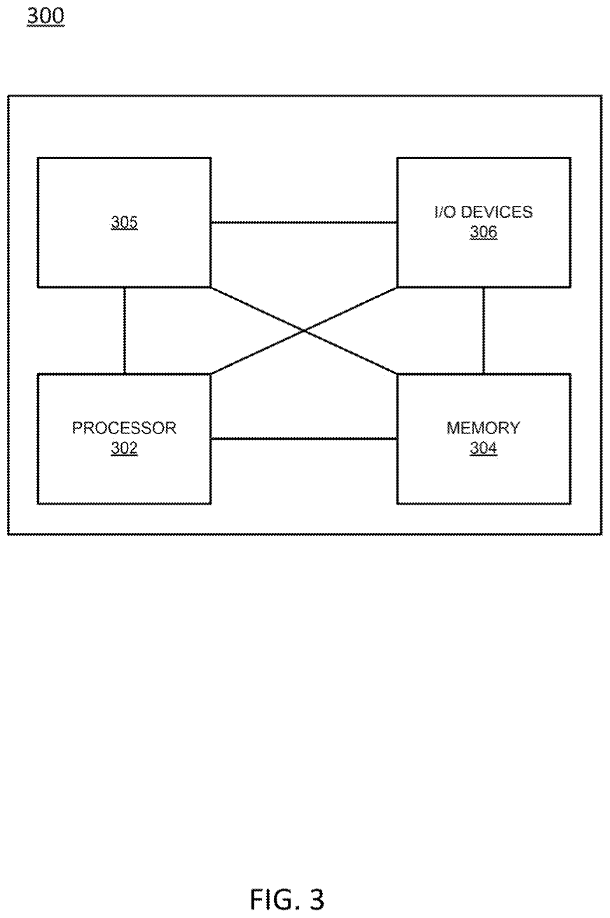

In accordance with the present disclosure, network 102 may include a plurality of application servers (AS) 104, each of which may comprise computing system or server, such as computing system 300 depicted in FIG. 3, and may be configured to provide one or more operations or functions in connection with an extended reality application. For instance, one AS 104 may support a service that streams immersive video, while another AS 104 may support a service that provides an XR gaming experience.

The network 102 may also include extended reality application management (XR-AM) entity 116, which may comprise a computing system or server, such as computing system 300 depicted in FIG. 3, and may be configured to provide one or more operations or functions in connection with examples of the present disclosure for providing flow-level coverage and bandwidth adaptation for an extended reality application. The network 102 may also include one or more databases (DBs) 106 that are communicatively coupled to the AS 104 and the XR-AM 116 as well as a plurality of edge routers 128-130.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure. Thus, although only a single XR-AM 116 and a single database (DB) 106 are illustrated in FIG. 1, it should be noted that any number of application servers, any number of extended reality application management entities, and any number of databases may be deployed, and which may operate in a distributed and/or coordinated manner as a processing system to perform operations in connection with the present disclosure.

In one example, XR-AM 116 may comprise a centralized network-based server for adapting bandwidth and coverage at the flow level for XR traffic. For instance, the XR-AM 116 may detect XR traffic flows exchanged between XR applications executing on various mobile user endpoint devices (UEs) 108, 110, 112, and 116 that are interacting with one of the application servers 104. Based on the varying needs of different types of traffic carried by the XR traffic flows, the XR-AM 116 may direct the UEs 108, 110, 112, and 114 and/or the radio access nodes (e.g., gNodeBs) serving the UEs 108, 110, 112, and 114, to adapt their transmit power, frequency band, and/or channel bandwidth on a per-user, per-bearer, per-flow, or per-group flow basis.

In one example, at least one AS 104 may comprise a physical storage device (e.g., a database server), to store a mapping table which maps individual flow and/or bearer identifiers to RAN-level metrics. In one example, the RAN-level metrics may include XR coverage metrics and XR energy metrics. In one example, an XR coverage metric may comprise measurements such as received signal power or strength (e.g., reference signal received power (RSRP), received signal strength indicator (RSSI), or the like), signal-to-interference-plus-noise ratio (SINR), or other measurements. In one example, an XR energy metric may comprise measurements such as instantaneous and average battery consumption, control and data channel utilization, uplink transmit power headroom reports (PHRs), discontinuous reception (DRX) utilization, measurement gap utilization, frequency band utilization (e.g., direct current/carrier aggregation/bandwidth part activation or deactivation). Thus, the RAN-level metrics may specify a required QoS for a flow or bearer whose identifier is associated with the RAN-level metrics.

In another example, the DB 106 may store the mapping table, and the XR-AM 116 and/or AS 104 may query the mapping table in the DB 106 (e.g., using a detected flow or bearer identifier as an index into the mapping table) when needed. For ease of illustration, various additional elements of network 102 are omitted from FIG. 1.

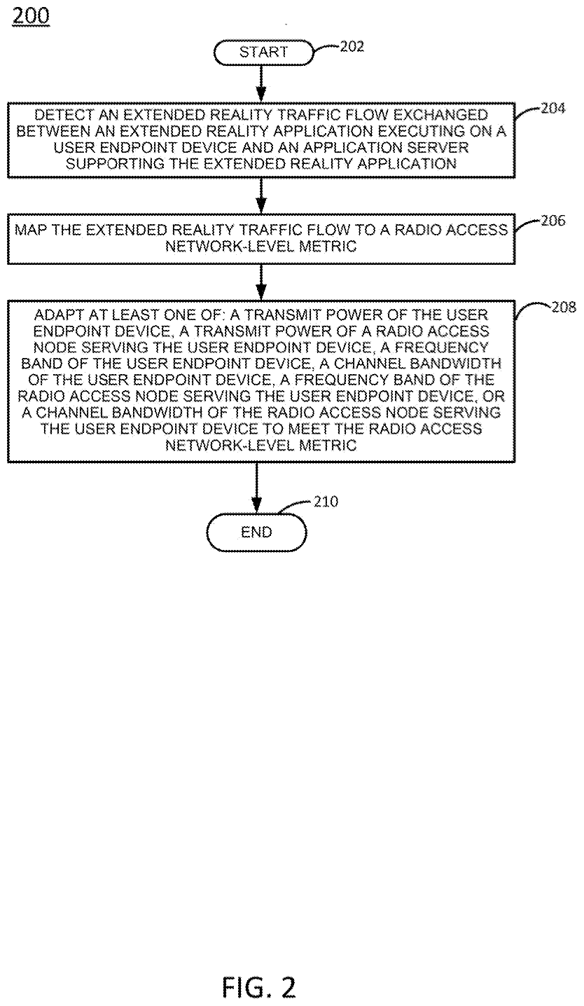

In one example, one or both of the access networks 120 and 122 may include an edge server (not shown), which may comprise a computing system or server, such as computing system 300 depicted in FIG. 3, and may be configured to provide one or more operations or functions for providing flow-level coverage and bandwidth adaptation for an extended reality application, as described herein. For instance, an example method 200 for providing flow-level coverage and bandwidth adaptation for an extended reality application is illustrated in FIG. 2 and described in greater detail below.

In one example, XR-AM 116 may comprise a network function virtualization infrastructure (NFVI), e.g., one or more devices or servers that are available as host devices to host virtual machines (VMs), containers, or the like comprising virtual network functions (VNFs). In other words, at least a portion of the network 102 may incorporate software-defined network (SDN) components. Similarly, in one example, access networks 120 and 122 may comprise “edge clouds,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 122 comprises radio access networks, the nodes and other components of the access network 122 may be referred to as a mobile edge infrastructure. As just one example, an edge server in access network 120 or 122 may be instantiated on one or more servers hosting virtualization platforms for managing one or more virtual machines (VMs), containers, microservices, or the like. In other words, in one example, the edge server may comprise a VM, a container, or the like.

In one example, the access network 120 may be in communication with one or more UEs, e.g., UEs 108 and 110. Similarly, access network 122 may be in communication with one or more UEs, e.g., UEs 112 and 114. Access networks 120 and 122 may transmit and receive communications between AS 104, XR-AM 116, Internet 124, server(s), user endpoint devices 108, 110, 112, and 114, other components of network 102, devices reachable via the Internet in general, and so forth. In one example, any or all of the UEs 108, 110, 112, and 114 may comprise a mobile device, a cellular smart phone, a wearable computing device (e.g., smart glasses, a virtual reality (VR) headset or other types of head mounted display, or the like), a laptop computer, a tablet computer, or the like. In one example, any or all of the UEs 108, 110, 112, and 114 may comprise a computing system or device, such as computing system 300 depicted in FIG. 3, and may be configured to execute one or more extended reality applications in conjunction with one or more application servers 104 in the core network 102.

In one example, server 126 may comprise a network-based server for providing flow-level coverage and bandwidth adaptation for an extended reality application, as described herein. In this regard, server 126 may comprise the same or similar components as those of XR-AM 116 and may provide the same or similar functions. Thus, any examples described herein with respect to XR-AM 116 may similarly apply to server 126, and vice versa. In particular, server 126 may be a component of a system for providing flow-level coverage and bandwidth adaptation for an extended reality application which is operated by an entity that is not a telecommunications network operator. For instance, a provider of an immersive application may operate server 126 and may also operate an edge server in access network 120 or access network 122 in accordance with an arrangement with a telecommunication service provider offering edge computing resources to third-parties. However, in another example, a telecommunication network service provider may operate network 102 and access network 122, and may also provide a system via XR-AM 116 and an edge server. For instance, in such an example, the system embodied in the XR-AM 116 may comprise an additional service that may be offered to subscribers, e.g., in addition to network access services, telephony services, traditional television services, media content delivery service, and so forth.

In an illustrative example, a UE 108, 110, 112, or 114 may execute an XR application that exchanges data with an AS 104 via a plurality of XR traffic flows in order to provide an XR experience to a user. For instance, the XR application may comprise an immersive video or XR gaming application. In one example, either or both of the access network 120 and the access network 122 may comprise a cellular network (e.g., a 4G network and/or an LTE network, or a portion thereof, such as an evolved Uniform Terrestrial Radio Access Network (eUTRAN), an evolved packet core (EPC) network, etc., a 5G network, a next generation network, etc.). Thus, the communications between UE 108, 110, 112, or 114 and access networks 120 and 122 may involve cellular communication via one or more base stations (e.g., eNodeBs, gNodeBs, or the like). However, in another example, the communications may alternatively or additional be via a non-cellular wireless communication modality, such as IEEE 802.11/Wi-Fi, or the like. For instance, access network 120 or 122 may comprise a wireless local area network (WLAN) containing at least one wireless access point (AP), e.g., a wireless router. Alternatively, or in addition, UE 108, 110, 112, or 114 may communicate with access networks 120 and 122, network 102, the Internet in general, etc., via a WLAN that interfaces with access network 120 or 122.

XR-AM 116 may detect the plurality of XR traffic flows and may further extract, for any given flow of the plurality of XR traffic flows, a flow or bearer identifier. The flow or bearer identifier may be used as an index into the mapping table stored in the DB 106 (or an AS 104) in order to map the given flow to one or more RAN-level metrics (e.g., XR coverage metrics and/or XR energy metrics) that define a required QoS for the given flow. Based on the RAN-level metrics, the XR-AM 116 may determine an adjustment to be made to the uplink transmit power of the UE 108, 110, 112, or 114, the downlink transmit power of a radio access node (e.g., gNodeB) serving the UE 108, 110, 112, or 114, a frequency band or channel bandwidth of the UE 108, 110, 112, or 114 or a frequency band or channel bandwidth of the radio access node (where the adaptation may be applied on a per-user, per-bearer, per-flow, or per-group flow basis). The XR-AM 116 may communicate the adjustment to the UE 108, 110, 112, or 114 and/or to the radio access node, so that the adjustment can be made to optimize the coverage and/or bandwidth for the given flow.

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In addition, as described above, the functions of XR-AM 116 may be similarly provided by server 126, or may be provided by XR-AM 116 in conjunction with server 126. For instance, XR-AM 116 and server 126 may be configured in a load balancing arrangement, or may be configured to provide for backups or redundancies with respect to each other, and so forth. Thus, these and other modifications are all contemplated within the scope of the present disclosure.

To further aid in understanding the present disclosure, FIG. 2 illustrates a flowchart of an example method 200 for providing flow-level coverage and bandwidth adaptation for an extended reality application in accordance with the present disclosure. In one example, the method 200 may be performed by XR application management entity, such as the XR-AM 116 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may detect an extended reality traffic flow exchanged between an extended reality application executing on a user endpoint device and an application server supporting the extended reality application.

In one example, the extended reality traffic flow may be one of a plurality of extended reality traffic flows exchanged between the extended reality application executing on the user endpoint device and the application server supporting the extended reality application. For instance, the extended reality application may include a plurality of components associated with a plurality of different XR traffic flows, such as multimedia components, interactivity components, user proximity or location components, and other components.

In step 206, the processing system may map the extended reality traffic flow to a radio access network (RAN)-level metric. In one example, the RAN-level metric may be at least one of: an XR coverage metric or an XR energy metric.

In one example, the XR coverage metric may comprise physical layer (e.g., L1) and higher layer (e.g., L2/L3) measurements such as received signal power or strength (e.g., reference signal received power (RSRP), received signal strength indicator (RSSI), or the like), signal-to-interference-plus-noise ratio (SINR), or other measurements. In one example, the XR coverage metric may be computed individually or jointly (e.g., as a maximum, a minimum, a mean, a weighted average, or the like) for the downlink and uplink directions. In a further example, the XR coverage metric may be computed individually for the control and data channels and signals (e.g., physical downlink control channel (PDCCH), physical uplink control channel (PUCCH), physical downlink shared channel (PDSCH), or physical uplink shared channel (PUSCH).

In one example, the XR energy metric may comprise physical layer (e.g., L1) and higher layer (e.g., L2/L3) measurements such as instantaneous and average battery consumption, control and data channel utilization, uplink transmit power headroom reports (PHR), discontinuous reception (DRX) utilization, measurement gap utilization, frequency band utilization (e.g., direct current/carrier aggregation/bandwidth part activation or deactivation).

In one example, the XR coverage and/or energy metrics may be provided by a 5G RAN node (e.g., a gNodeB central unit and/or a gNodeB distributed unit) on the basis of a per-bearer or per-flow identifier. The mapping of the RAN-level metric (e.g., extended reality coverage metric and/or extended reality energy metric) to the bearer or flow identifier may be provided over the core network signaling or via an operation, administration, and management (OAM) interface, such as a radio interface controller (RIC). In one example, the RAN-level metric may be provided via individual elements via the RAN network, the core network, or OAM signaling. In another example, the RAN-level metric may be provided via a preconfigured mapping table, and an index to the mapping table may be associated with the bearer or flow identifier.

In one example, the mapping of RAN-level metrics to bearer or flow identifiers is 1:1. In this case, the RAN-level metrics provided for a given bearer or flow identifier are unique to that given bearer or flow identifier. In another example, the mapping of RAN-level metrics to bearer or flow identifiers is 1:N. In this case, the RAN-level metrics provided for a given bearer or flow identifier are unique to a subset of N bearer or flow identifiers including the given bearer or flow identifier. In the case of a 1:N mapping, the grouping of the RAN-level metrics may be provided via higher layer signaling. In one example, the grouping of the RAN-level metrics may be configured based on quality of service (QoS) characteristics such as QoS class identifier (QCI). In another example, the grouping of the RAN-level metrics may be configured based on traffic type (e.g., VR, AR, or CG traffic).

In one example, the RAN-level metrics associated with one or more bearer or flow identifiers may be provided outside of the RAN to an XR application management entity (e.g., XR-AM 116 of FIG. 1), which may be deployed in a co-located manner with the RAN and/or core network, or may reside outside of the network at the application server supporting the extended reality application (e.g., AS 104 of FIG. 1) or at a user endpoint device executing one or more XR applications (e.g., UEs 108, 110, 112, and/or 114 of FIG. 1).

In step 208, the processing system may adapt at least one of: the transmit power of the user endpoint device, the transmit power of a radio access node (e.g., gNodeB) serving the user endpoint device, the frequency band of the user endpoint device, the channel bandwidth of the user endpoint device, a frequency band of the radio access node serving the user endpoint device, or a channel bandwidth of the radio access node serving the user endpoint device to meet the RAN-level metric.

In one example, adapting the transmit power of the user endpoint device or the radio access node may comprise providing an updated transmit power value (or range of transmit power values depending upon the adaptation, as discussed in further detail below) to the user endpoint device and/or the radio access node for implementation. In further examples, the processing system may also provide updated RAN-level metrics (i.e., XR coverage and/or XR energy metrics) to the user endpoint device and/or the radio access node. The updated RAN-level metrics may be based on network or service policy updates and/or historical network data used as training data by a machine learning model which predicts the transmit power needed to meet QoS requirements while meeting any constraints of the RAN-level metrics.

In one example, the transmit power of the user endpoint device may be the uplink transmit power of the user endpoint device, while the transmit power of a radio access node may be the downlink transmit power of the radio access node. The transmit power may be adapted on a per-user, per-bearer, per-flow, or per-group flow basis. The adapted transmit power may be used by the processing system to compute an expected radio quality metric (e.g., RSRP, SNR, SINR, or the like), which can in turn be used to determine an expected air interface performance metric (e.g., throughput, latency, packet error rate, or the like) which can be mapped onto a corresponding QoS requirement for the detected XR traffic flow or service associated with the XR traffic flow.

For instance, in one example where the RAN-level metric is an XR coverage metric, the XR coverage metric may be indicated as a minimum transmit power of the gNodeB or the user endpoint device needed to meet a QoS requirement of the detected XR traffic flow (or bearer). In one example, the minimum transmit power may be expressed as an absolute value (e.g., X dBm). In another example, the minimum transmit power may be expressed as a ratio or relative offset value from a reference transmit power value (e.g., X dB), where the reference transmit power value may be the maximum transmit power of the user endpoint device or the configured transmit power by the network (e.g., via closed loop or open loop power control commands).

In another example where the RAN-level metric is an XR coverage metric, the XR coverage metric may be indicated as a transmit power range of the gNodeB or the user endpoint device needed to meet a QoS requirement of the detected XR traffic flow (or bearer). In one example, the transmit power range may be expressed as a pair of a minimum value and a maximum value for the range. In another example, the transmit power range may indicate additional values between the minimum value and the maximum value with a preconfigured or pre-specified quantization level.

In one example where the RAN-level metric is an XR energy metric, the XR energy metric may be indicated as an average transmit power of the gNodeB or the user endpoint device needed to meet a QoS requirement of the detected XR traffic flow (or bearer) for a specified time duration. In one example, the specified time duration may correspond to a configurable plurality of time slots within a frame of the XR traffic flow (or bearer). In another example, the specified time duration may correspond to a configured number of packets to be successfully transmitted within a frame of the XR traffic flow (or bearer). In another example, the specified time duration may correspond to a pre-configured timer which may be set by higher layers of the network and may be triggered by network or device events (e.g., battery level thresholds, user interaction levels, device processor or modem utilization, network traffic levels, serving or neighbor cell measurements, interference measurements, and the like).

In one example, the transmit power value or values discussed above may be provided for all signals and channels. In another example, the transmit power value or values discussed above may be provided for a subset of signals and channels (e.g., broadcast channels only, control channels only, data channels only, etc.). In another example, the transmit power value or values discussed above may be provided for transmissions on a subset of transmit and receive beams (e.g., beam index or quasi co location index).

The frequency band of the user endpoint device, the channel bandwidth of the user endpoint device, the frequency band of the radio access node serving the user endpoint device, or the channel bandwidth of the radio access node serving the user endpoint device may be adapted on a per-user, per-bearer, per-flow, or per-group flow basis.

For instance, in one example where the XR coverage metric and/or XR energy metric is provided per frequency band, the XR coverage metric and XR energy metric may correspond to the carrier frequency of the band and the carrier bandwidth value(s) of the carriers supported on the band. The carrier frequency and bandwidth may be utilized to calculate a propagation characteristic which may determine the transmit power or energy utilization of the radio access node or the user endpoint device indicated by the XR coverage metric or the XR energy metric, respectively. In another example, the propagation characteristic of the frequency band may be inferred by the processing system (e.g., using machine learning) from historical measurements from user endpoint devices corresponding to the carrier frequency and bandwidth of a carrier within the indicated frequency band.

In another example where the XR coverage metric and/or XR energy metric is provided per component carrier or bandwidth part within a component carrier, the XR coverage metric and XR energy metric may correspond to the frequency location of the synchronization signal block (SSB) within the component carrier and the carrier bandwidth of the initial bandwidth part of the component carrier. In another example, the XR coverage metric and XR energy metric may correspond to the frequency range (e.g., physical resource block index and number of physical resource blocks).

In another example, the XR coverage metric and/or XR energy metric may be associated with an activity factor over a time duration which corresponds to the activation/deactivation commands for a given component carrier or bandwidth part. In a further example, the activity factor may also include the time/frequency resources utilized by the component carrier or bandwidth part for measurements (e.g., reference signal configurations and measurement gap configurations). In another example, the XR coverage metric and/or XR energy metric may be associated with energy saving parameters at the user endpoint device (e.g., discontinuous reception timers and patterns) or at the radio access node (e.g., wake up and paging signal transmission or reception).

In the case of carrier aggregation or dual connectivity, the XR coverage metric and XR energy metric may be provided for multiple bands (e.g., inter-band carrier aggregation or direct current) or multiple carriers (e.g., intra-band carrier aggregation or direct current). In one example, the XR coverage metric and XR energy metric may be provided independently for each band or carrier, and the processing system may select a subset of frequency bands/carriers to map to the XR traffic flow (or bearer). In another example, the XR coverage metric and XR energy metric may be provided from the user endpoint device or the radio access node in an aggregated manner for a configured combination of bands or carriers corresponding to the XR traffic flow (or bearer). In another example, the XR coverage metric and XR energy metric may be provided individually or jointly for downlink and uplink resources within a given set of frequency bands, carriers, or bandwidth parts.

In one example, the processing system may request the bandwidth capabilities (in terms of support bands, direct current/carrier aggregation combinations, and bandwidth part adaptation (e.g., adaptation latency, bandwidth part size, total number of active bandwidth parts, and the like)) of the user endpoint device as those bandwidth capabilities relate to computing the XR coverage metric and XR energy metric. Then, once the XR traffic flow has been mapped to the XR coverage metric and XR energy metric, the processing system may provide updated frequency bandwidth values to the user endpoint device and/or radio access node and may further provide updated XR coverage and XR energy metrics based on network or service policy updates and/or historical network data (used as training data by a machine learning model which generates predictions about the transmit power needed to meet QoS requirements while meeting the constraints of the XR coverage and XR energy metrics).

After the processing system has adapted at least one of: the transmit power of the user endpoint device, the transmit power of a radio access node (e.g., gNodeB) serving the user endpoint device, the frequency band of the user endpoint device, the channel bandwidth of the user endpoint device, a frequency band of the radio access node serving the user endpoint device, or a channel bandwidth of the radio access node serving the user endpoint device to meet the RAN-level metric, the method 200 may end in step 210. However, it should be noted that where the extended reality traffic flow is one of a plurality of extended reality traffic flows exchanged between the extended reality application executing on the user endpoint device and the application server supporting the extended reality application, the method 200 may be repeated (or simultaneously performed) for one or more other flows of the plurality of extended reality traffic flows.

Thus, the method 200 may adapt the coverage and/or bandwidth for an XR application at the network traffic flow level. This may allow different flows carrying different traffic which may be associated with the same XR application (e.g., a flow carrying multimedia traffic, a flow carrying interactivity traffic, etc.) to be differentiated and to be independently and simultaneously optimized so that the overall user experience with the XR application meets some required QoS.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, an extended reality application management entity (such as might be used to perform the method 200) could be implemented as illustrated in FIG. 3.

As depicted in FIG. 3, the system 300 comprises a hardware processor element 302, a memory 304, a module 305 for providing flow-level coverage and bandwidth adaptation for an extended reality application, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for providing flow-level coverage and bandwidth adaptation for an extended reality application may include circuitry and/or logic for performing special purpose functions relating to the allocation of network resources. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for providing flow-level coverage and bandwidth adaptation for an extended reality application (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for providing flow-level coverage and bandwidth adaptation for an extended reality application (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
detecting, by a processing system including at least one processor, an extended reality traffic flow exchanged between an extended reality application executing on a user endpoint device and an application server supporting the extended reality application;
mapping, by the processing system, the extended reality traffic flow to a radio access network-level metric; and
adapting, by the processing system, at least one of: a transmit power of the user endpoint device, a transmit power of a radio access node serving the user endpoint device, a frequency band of the user endpoint device, a channel bandwidth of the user endpoint device, a frequency band of the radio access node serving the user endpoint device, or a channel bandwidth of the radio access node serving the user endpoint device to meet the radio access network-level metric.

2. The method of claim 1, wherein the extended reality traffic flow is one of a plurality of extended reality traffic flows exchanged between the extended reality application executing on the user endpoint device and the application server supporting the extended reality application.

3. The method of claim 2, wherein each flow of the plurality of extended reality traffic flows carries traffic associated with a different component of the extended reality application.

4. The method of claim 1, wherein the radio access network-level metric is an extended reality coverage metric.

5. The method of claim 4, wherein the extended reality coverage metric comprises physical layer and higher layer measurements.

6. The method of claim 5, wherein the measurements comprise measurements of at least one of: a reference signal received power, a received signal strength indicator, or a signal-to-interference-plus-noise ratio.

7. The method of claim 4, wherein the radio access network-level metric is a extended reality energy metric, and wherein the extended reality energy metric comprises physical layer and higher layer measurements.

8. The method of claim 7, wherein the measurements comprise measurements of at least one of: an instantaneous battery consumption, an average battery consumption, a control channel utilization, a data channel utilization, an uplink transmit power headroom report, a discontinuous reception utilization, a measurement gap utilization, or a frequency band utilization.

9. The method of claim 1, wherein the radio access network-level metric is mapped to an identifier of the extended reality traffic flow.

10. The method of claim 9, wherein the radio access network-level metric is mapped to the identifier of the extended reality traffic flow in a mapping table, and an index to the mapping table is associated with the identifier.

11. The method of claim 9, wherein the identifier is uniquely associated with the extended reality traffic flow.

12. The method of claim 9, wherein the identifier is uniquely associated with a group of extended reality traffic flows including the extended reality traffic flow.

13. The method of claim 1, wherein the adapting the transmit power of the user endpoint device comprises providing, to the user endpoint device, an updated transmit power value or an updated range of transmit power values.

14. The method of claim 1, wherein the adapting the transmit power of the radio access node serving the user endpoint device comprises providing, to the radio access node serving the user endpoint device, an updated transmit power value or an updated range of transmit power values.

15. The method of claim 1, wherein the radio access network-level metric is associated with an energy saving parameter for at least one of: the user endpoint device or the radio access node serving the user endpoint device.

16. The method of claim 1, wherein the adapting further comprises providing an updated radio access network-level metric to at least one of: the user endpoint device or the radio access node serving the user endpoint device.

17. The method of claim 16, wherein the updated radio access network-level metric is based on a network or service policy update.

18. The method of claim 16, wherein the updated radio access network-level metric is based on historical network data.

19. A non-transitory computer-readable medium storing instructions which, when executed by a processing system including at least one processor, cause the processing system to perform operations, the operations comprising:
detecting an extended reality traffic flow exchanged between an extended reality application executing on a user endpoint device and an application server supporting the extended reality application;
mapping the extended reality traffic flow to a radio access network-level metric; and
adapting at least one of: a transmit power of the user endpoint device, a transmit power of a radio access node serving the user endpoint device, a frequency band of the user endpoint device, a channel bandwidth of the user endpoint device, a frequency band of the radio access node serving the user endpoint device, or a channel bandwidth of the radio access node serving the user endpoint device to meet the radio access network-level metric.

20. A device comprising:
a processing system including at least one processor; and
a computer-readable medium storing instructions which, when executed by the processing system, cause the processing system to perform operations, the operations comprising:
detecting an extended reality traffic flow exchanged between an extended reality application executing on a user endpoint device and an application server supporting the extended reality application;
mapping the extended reality traffic flow to a radio access network-level metric; and
adapting at least one of: a transmit power of the user endpoint device, a transmit power of a radio access node serving the user endpoint device, a frequency band of the user endpoint device, a channel bandwidth of the user endpoint device, a frequency band of the radio access node serving the user endpoint device, or a channel bandwidth of the radio access node serving the user endpoint device to meet the radio access network-level metric.
